(19) United States
(12) Patent Application Publication
(10) Pub. No.: US 2018/0150326 A1
(43) Pub. Date: May 31, 2018

(54) METHOD AND APPARATUS FOR EXECUTING TASK IN CLUSTER

(71) Applicant: ALIBABA GROUP HOLDING LIMITED, George Town (KY)

(72) Inventors: Chen XIA, Hangzhou (CN); Changliang XU, Hangzhou (CN); Yanming ZHANG, Hangzhou (CN)

(73) Assignee: ALIBABA GROUP HOLDING LIMITED

(21) Appl. No.: 15/880,432

(22) Filed: Jan. 25, 2018

Related U.S. Application Data
(63) Continuation of application No. PCT/CN2016/090617, filed on Jul. 20, 2016.

(30) Foreign Application Priority Data
Jul. 29, 2015 (CN) 201510455382.1

(51) Int. Cl. G06F 9/50; G06F 9/38; G06F 9/48

(52) U.S. Cl. CPC G06F 9/5005; G06F 9/5077; G06F 9/4881; G06F 9/485; G06F 9/3891

(57) ABSTRACT

The present disclosure discloses a method and an apparatus for executing a task in a cluster. The method includes: obtaining a task; determining a cluster-resource collection corresponding to the task in a plurality of pre-grouped collections of cluster resource, according to attribute of the task; and executing the task by a cluster resource in the determined cluster-resource collection. By means of this method, different tasks may correspond to different cluster resource collections. A task may occupy only a cluster resource included in a cluster-resource collection corresponding to the task, instead of occupying all cluster resources in a cluster. Therefore, even when a task occupies all cluster resources included in a cluster-resource collection corresponding to the task, the cluster can still use a cluster resource included in another cluster-resource collection to execute other tasks corresponding to other cluster resource collections in a timely manner.

### CROSS REFERENCE TO RELATED APPLICATION

The present application claims priority to International Application PCT/CN2016/090617, filed on Jul. 20, 2016, which is based on and claims the benefits of priority to Chinese Application No. 201510455382.1, filed Jul. 29, 2015, both of which are incorporated herein by reference in their entireties.

### TECHNICAL FIELD

The present application relates to the field of computer technologies, and in particular, to a method and an apparatus for executing a task in a cluster.

### BACKGROUND

In a large busy cluster of a computing system, numerous tasks may be received every day. The cluster of the computing system may be a cluster used to provide services such as cloud computing and big data processing.

Generally, a cluster may sequentially execute tasks in chronological order according to task acquisition time by using cluster resources. Data volumes of tasks may be different. A task with a relatively large data volume is referred to as a larger task, and a task with a small data volume is referred to as a medium/smaller task. A data volume threshold for distinguishing between a larger task and a medium/smaller task may be set by the cluster.

However, in a process of executing a larger task by a cluster, all the cluster resources may be occupied for a long time. In this case, numerous medium/smaller tasks may have to wait for a long time as no cluster resource is attainable for medium/smaller tasks through contention. The cluster can only execute the medium/smaller tasks in waiting after the execution of the larger task is complete and cluster resources occupied by the larger task are released.

Therefore, when a cluster executes tasks in the task execution manner of the prior art, the cluster cannot execute waiting tasks in a timely manner due to a task, e.g., the larger task described above, occupies all cluster resources for a long time may arise.

### SUMMARY

Embodiments of the present disclosure provide a method and an apparatus for executing a task in a cluster to resolve the problem that a cluster cannot execute waiting tasks in a timely manner as a larger task occupies all cluster resources for a long time.

A method for executing a task in a cluster provided by embodiments of the present disclosure includes obtaining a to-be-executed task, determining, in multiple pre-grouped cluster-resource collections , a cluster-resource collection corresponding to the to-be-executed task according to an attribute of the to-be-executed task, and executing the to-be-executed task by using a cluster resource included in the determined cluster-resource collection.

An apparatus for executing a task in a cluster provided by embodiments of the present disclosure includes an obtaining module configured to obtain a to-be-executed task, a determining module configured to determine, in cluster-resource collection formed after grouping in advance, a cluster-resource collection corresponding to the to-be-executed task according to a specified attribute of the to-be-executed task, and an execution module configured to execute the to-be-executed task by using a cluster resource included in the determined cluster-resource collection.

In the embodiments of the present disclosure, by using at least one technical solution described above, different to-be-executed tasks may correspond to different cluster-resource collection. Any to-be-executed task may occupy only a cluster resource included in a cluster-resource collection corresponding to the to-be-executed task, instead of occupying all cluster resources in a cluster. Therefore, even if a certain to-be-executed task occupies all cluster resources included in a cluster-resource collection corresponding to the to-be-executed task for a long time, the cluster can still use a cluster resource included in another cluster-resource collection to execute another to-be-executed task corresponding to another cluster-resource collection in a timely manner.

### BRIEF DESCRIPTION OF THE DRAWINGS

The accompanying drawings described herein are used to provide further understanding of the present disclosure, and constitutes a part of the present disclosure. Exemplary embodiments of the present disclosure and illustrations thereof are used to explain the present disclosure, and are not intended to form any improper limitation on the present disclosure. In the accompanying drawings:

FIG. 1 is a flow chart illustrating an exemplary process of executing a task in a cluster, consistent with embodiments of the present disclosure.

FIG. 2 is a schematic diagram illustrating exemplary cluster architecture for executing a task in a cluster, consistent with embodiments of the present disclosure.

FIG. 3 is a flow chart illustrating an exemplary process of executing a task in a cluster, consistent with embodiments of the present disclosure.

FIG. 4 is a schematic diagram illustrating an exemplary apparatus for executing a task in a cluster, consistent with embodiments of the present disclosure.

### DETAILED DESCRIPTION OF PREFERRED EMBODIMENTS

To make objectives, technical solutions and advantages of the present disclosure clearer, technical solutions of the present disclosure are described through specific embodiments of the present disclosure and corresponding accompanying drawings. Apparently, the described embodiments are representative of the present disclosure. Based on the embodiments of the present disclosure, all other embodiments derived by those of ordinary skill in the art without any creative effort shall fall within the protection scope of the present disclosure.

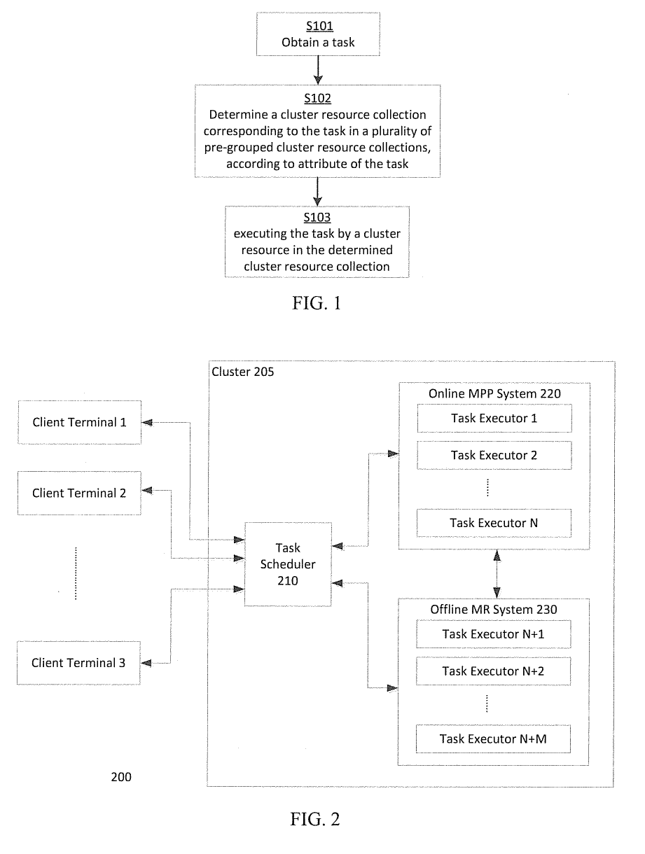

Reference is now made to FIG. 1, which is a flow chart illustrating an exemplary process of executing a task in a cluster, consistent with embodiments of the present disclosure. The process includes steps explained in detail below.

At step S101, a to-be-executed task is obtained. In the embodiments of the present disclosure, a user may submit a to-be-executed task to a cluster by using a client terminal corresponding to the cluster. The cluster may obtain the to-be-executed task.

The cluster may be a Hadoop cluster, or a cluster based on another distributed architecture, or the like. In practice, the cluster may be used to provide services such as cloud computing and big data processing. Each step in the task execution method may be performed by one or more machines in the cluster. The machine may be a task scheduler and/or a task executor in the cluster.

The to-be-executed task may be a specified operation that aims at specified data and requests to be performed by the cluster. For example, assuming that a user intends to query the total number of times that a technical term (referred to as a technical term a) appears in all dissertations in a dissertation database, the user may submit a query task to the cluster. The query task may include key words for query, and information related to all the dissertations, such as address indexes of all the dissertations. The cluster may determine a data volume of the query task according to the information included in the query task. The data volume may be the size of a file storing all the dissertations. In this example, the specified data described above refers to the file storing all the dissertations, and the specified operation described above refers to querying times that the technical term appears.

It is appreciated that, in addition to the query operation in the foregoing example, the specified operation may further be a deletion operation, a modification operation, a creation operation, or an authorization operation. An operation manner and operation content of the specified operation related to the to-be-executed task is not limited in the present disclosure.

In the embodiments of the present disclosure, the cluster may simultaneously obtain multiple to-be-executed tasks, or may sequentially obtain all to-be-executed tasks in a task queue based on a task queue manner. At step S101, when the cluster obtains more than one to-be-executed task, the cluster may separately perform subsequent steps for each obtained to-be-executed task. For ease of description, a to-be-executed task mentioned in the subsequent steps may refer to any one of the to-be-executed tasks obtained by the cluster.

At step S102, in multiple pre-grouped cluster-resource collections, a cluster-resource collection corresponding to the to-be-executed task is determined according to attribute of the to-be-executed task. Collections of cluster resource can be pre-grouped to various resource groups prior to the process of execution of task, e.g., online massively parallel processing (MPP) system, offline massive processing MR system, etc. These resource groups may have similar structure and computing capability. They are to be explained in further detail below.

In the embodiments of the present disclosure, the cluster resource may be a computational resource used in the execution of the to-be-executed task. The cluster resource may be categorized by different measures, including but not limited to the following three:

The measure can be the number of machine. In this case, any machine in the cluster may be used as one unit of cluster resource. For a pre-grouped cluster-resource collection, the cluster-resource collection may include a number of machines.

The measure can also be the number of Central Processing Unit (CPU). In this case, any CPU (where a multi-core machine may have multiple CPUs) in any machine in the cluster may be used as one unit of the cluster resource. For a pre-grouped cluster-resource collection, the cluster-resource collection may include a first number of CPUs.

The measure can also be the number of processes for executing a task. In this case, any process (where an operating system allocates a computational resource such as a CPU time slice or memory to the process) for executing a task in any machine in the cluster may be used as one unit of cluster resource. For a pre-grouped cluster-resource collection, the cluster-resource collection may include a second number of processes for executing a task.

In embodiments of the present disclosure, all the cluster resources included in the cluster may be grouped into at least two cluster-resource collections in advance. Any cluster resource included in each cluster-resource collection may be used by the cluster, so that the cluster executes, by using the cluster resource included in the cluster-resource collection, a to-be-executed task corresponding to the cluster-resource collection.

For example, in the pre-grouped cluster-resource collections , one cluster-resource collection (or multiple cluster-resource collections) may be used by the cluster to execute a larger task, and another cluster-resource collection (or other multiple cluster-resource collections) may be used by the cluster to execute a medium/smaller task. In this way, a cluster resource required for executing the medium/smaller task is not occupied during execution of the larger task. Therefore, efficiency of executing the medium/smaller task can be improved.

For the foregoing example, the attribute of the to-be-executed task in step S102 may include a data volume. Generally, the data volume of the to-be-executed task may reflect the scale of the task. When the data volume of the to-be-executed task is not greater than a set data volume threshold, the to-be-executed task can be considered as a medium/smaller task. When the data volume of the to-be-executed task is greater than the set data volume threshold, the to-be-executed task can be considered as a larger task. Multiple data volume thresholds may be set. Multiple data volume intervals may be obtained through division by using the multiple data volume thresholds. To-be-executed tasks having data volumes that fall within a same data volume interval may correspond to a same cluster-resource collection.

Further, the attribute of a to-be-executed task may also be a task execution manner, a task priority, and the like.

When the attribute is a task execution manner, the task execution manner may be online execution or offline execution. The online execution may mean that the execution body is connected to the Internet when executing a task in order to rapidly return an execution result. The offline execution may mean that the execution body is not connected to the Internet when executing a task. In practice, for a medium/smaller task, user's demand on the speed of returning an execution result is relatively high, the cluster may execute the medium/smaller task online. For a larger task, user's demand on the speed of returning an execution result is relatively low, and the cluster may execute the larger task offline. It should be noted that, the task execution manner may be specified by the user, or by the cluster.

When the attribute of a to-be-executed task is a task priority, if the to-be-executed tasks submitted by user to the cluster have different task priorities, the cluster preferentially executes a to-be-executed task with a higher task priority. To-be-executed tasks with the same task priority may be correspondingly grouped into one cluster-resource collection. Accordingly, tasks with different task priorities do not occupy cluster resources allocated to one another.

In these embodiments of the present disclosure, the pre-grouped cluster-resource collections may include a different numbers of cluster resources. Assuming the attribute is data volume, because execution of a larger task requires more cluster resources, when grouping is performed in advance to form the cluster-resource collections, the cluster-resource collection corresponding to the larger task may be made to include more cluster resources. For example, it may include 80% of all cluster resources. Correspondingly, the cluster-resource collection corresponding to the medium/smaller task may include 20% of all cluster resources. Accordingly, a load balancing capability of the cluster can be improved, so that the cluster can obtain sufficient cluster resources when executing both a larger task and a medium/smaller task.

At step S103, the to-be-executed task is executed by a cluster resource included in the determined cluster-resource collection.

By means of the foregoing method, different to-be-executed tasks may correspond to different cluster-resource collections. Any to-be-executed task may occupy only a cluster resource included in a cluster-resource collection corresponding to the to-be-executed task, instead of occupying all cluster resources in a cluster. Therefore, even if a to-be-executed task occupies all cluster resources included in the cluster-resource collection corresponding to the to-be-executed task for a long time, the cluster can still use a cluster resource in another cluster-resource collection to execute in a timely manner another to-be-executed task corresponding to another cluster-resource collection.

For example, when the attribute is a data volume, a larger task and a medium/smaller task may separately correspond to different cluster-resource collections. In this case, the larger task may occupy only a cluster resource included in a cluster-resource collection corresponding to the larger task, instead of occupying a cluster resource included in a cluster-resource collection corresponding to the medium/smaller task. Therefore, when executing the larger task, the cluster may also use the cluster resource in the cluster-resource collection corresponding to the medium/smaller task, to execute the medium/smaller task. Therefore, the cluster can execute the medium/smaller task in a timely manner.

In these embodiments of the present disclosure, the cluster may execute the medium/smaller task online, and the larger task offline. In some embodiments, at step S102, the cluster-resource collections include at least a cluster-resource collection for providing a cluster resource for executing a task online, and a cluster-resource collection for providing a cluster resource for executing a task offline.

Further, at step S103, when the determined cluster-resource collection is the cluster-resource collection for providing a cluster resource for executing a task online, the execution of the to-be-executed task may include: executing the to-be-executed task online.

When the determined cluster-resource collection is the cluster-resource collection for providing a cluster resource for executing a task offline, the execution of the to-be-executed task may include executing the to-be-executed task offline.

In practice, the cluster-resource collection providing a cluster resource for executing a task online and machines that execute a task online in the cluster may form a complete system. This system may be referred to as an online MPP system. Specifically, the online MPP system may be a system having a resident process (such as Impala or Sql On Spark) and may rapidly execute a medium/smaller task online.

Correspondingly, the cluster-resource collection providing a cluster resource for executing a task offline and machines that execute a task offline in the cluster may also form a complete system. The system may be referred to as an offline MapReduce (MP) system. Specifically, the offline MP system may be an offline big data processing system (such as Hadoop) that implements a computation model.

Further, at step S102, when the attribute includes data volume, the determining of a cluster-resource collection corresponding to the to-be-executed task may include: determining whether the data volume of the to-be-executed task is not greater than a data volume threshold. If the data volume of the to-be-executed task is not greater than a data volume threshold, the determination includes determining the cluster-resource collection for providing a cluster resource for executing a task online as the cluster-resource collection corresponding to the to-be-executed task. If the data volume of the to-be-executed task is greater than a data volume threshold, the determination includes determining the cluster-resource collection for providing a cluster resource for executing a task offline as the cluster-resource collection corresponding to the to-be-executed task.

For example, assuming that the data volume threshold is 1 GigaByte (GB) and the to-be-executed task is a query task, after obtaining the query task, the cluster may determine whether a data volume that needs to be queried for executing the query task is not greater than 1 GB.

If the data volume of the to-be-executed task is not greater than 1 GB, the query task is considered to be a medium/smaller task. Therefore, it may be determined that the query task corresponds to the cluster-resource collection for providing a cluster resource for executing a task online. Further, the online MPP system in the cluster may execute the query task online by using a cluster resource in the cluster-resource collection for providing a cluster resource for executing a task online.

If the data volume of the to-be-executed task is greater than 1 GB, the query task is considered to be a larger task. Therefore, it may be determined that the query task corresponds to the cluster-resource collection for providing a cluster resource for executing a task offline. Further, the offline MP system in the cluster may execute the query task offline by using a cluster resource in the cluster-resource collection for providing a cluster resource for executing a task offline.

After obtaining the to-be-executed task, the cluster may further decompose the to-be-executed task into a number of task instances (where the task instance may also be referred to as a subtask). Subsequently, the task instances may be separately submitted to different processes in the cluster for separate execution. In addition, after the task instances are finished, execution results of the task instances are collected and combined, to obtain an execution result of the to-be-executed task. It should be noted that, a method used by the cluster to decompose the to-be-executed task is not limited in the present disclosure. Decomposition may be performed according to data volume, or according to another attribute of the to-be-executed task.

At step S102, the attribute may also be the number of task instances decomposed from the to-be-executed task. The determining of a cluster-resource collection corresponding to the to-be-executed task may include determining whether the number of the task instances decomposed from the to-be-executed task is not greater than an instance number threshold. If the number of the task instances decomposed from the to-be-executed task is not greater than an instance number threshold, determining the cluster-resource collection for providing a cluster resource for executing a task online as the cluster-resource collection corresponding to the to-be-executed task. If the number of the task instances decomposed from the to-be-executed task is greater than an instance number threshold, determining the cluster-resource collection for providing a cluster resource for executing a task offline as the cluster-resource collection corresponding to the to-be-executed task.

For example, assuming that the instance number threshold is 4, the to-be-executed task is a query task, and data volume of the query task is 1 GB and that the cluster decomposes task instances from the query task according to the data volume and a data volume of each task instance is set to 256 MBytes (MB), the query task may be decomposed into four task instances. It can be seen that, the number of the task instances is not greater than the instance number threshold. Therefore, it may be determined that the query task corresponds to the cluster-resource collection for providing a cluster resource for executing a task online. Further, the online MPP system in the cluster may execute the query task online by using a cluster resource in the cluster-resource collection for providing a cluster resource for executing a task online.

In some instances, the cluster-resource collection for providing a cluster resource for executing a task offline includes more cluster resources than the cluster-resource collection for providing a cluster resource for executing a task online. Accordingly, a cluster capability of executing a task offline may be stronger than a capability of executing a task online.

In an actual application, it may take a relatively long time to execute some medium/smaller tasks by using a cluster resource in the cluster-resource collection for providing a cluster resource for executing a task online. Consequently, subsequent medium/smaller tasks cannot be executed in a timely manner. In these situations, these medium/smaller tasks may also be executed by using a cluster resource in the cluster-resource collection for providing a cluster resource for executing a task offline. Therefore, congestion of the medium/smaller tasks in the cluster can be prevented.

At step S103, when the to-be-executed task is executed online, the method may further include timing the process of executing the to-be-executed task online. The method may further include when the measured duration is greater than a duration threshold, stopping executing the to-be-executed task online, and releasing a cluster resource occupied by the to-be-executed task. The method can also include executing the to-be-executed task offline by using the cluster-resource collection for providing a cluster resource for executing a task offline. As an example, the duration threshold may be set to 600 seconds.

It should be noted that, values of the data volume threshold, the instance number threshold, and the duration threshold are not limited in the present disclosure. These thresholds each may be set according to an actual application scenario.

In embodiments of the present disclosure, after the pre-grouping of cluster-resource collections, execution processes of the to-be-executed tasks by the cluster based on the cluster-resource collection and execution results may be further recorded in a form of a log. Through analyzing the log, a load balancing status in the cluster can be determined, and further, cluster resources in the cluster-resource collection may be adjusted regularly or irregularly according to the load balancing status, to optimize the load balancing status in the cluster.

For example, if it is discovered by analyzing logs from the past week that, execution of medium/smaller tasks online is often prolonged, but for the cluster-resource collection for providing a cluster resource for executing a task offline, some cluster resources are often in an idle state. In these cases, these cluster resources that are often in an idle state may be re-allocated to the cluster-resource collection for providing a cluster resource for executing a task online, so as to execute the medium/smaller tasks online, thereby optimizing the load balancing status in the cluster.

Reference is now made to FIG. 2, which is a schematic diagram illustrating exemplary cluster architecture for executing a task in a cluster, consistent with embodiments of the present disclosure.

As shown in FIG. 2, a computing system 200 can include L client terminals and a cluster 205. Cluster 205 includes: a task scheduler 210, an online MPP system 220, and an offline MR system 230. Online MPP system 220 includes N task executors. Offline MR system 230 includes M task executors.

Online MPP system 220 may include a cluster-resource collection for providing a cluster resource for executing a task online. Offline MR system 230 may include a cluster-resource collection for providing a cluster resource for executing a task offline. A cluster resource included in the cluster-resource collection may be a task executor.

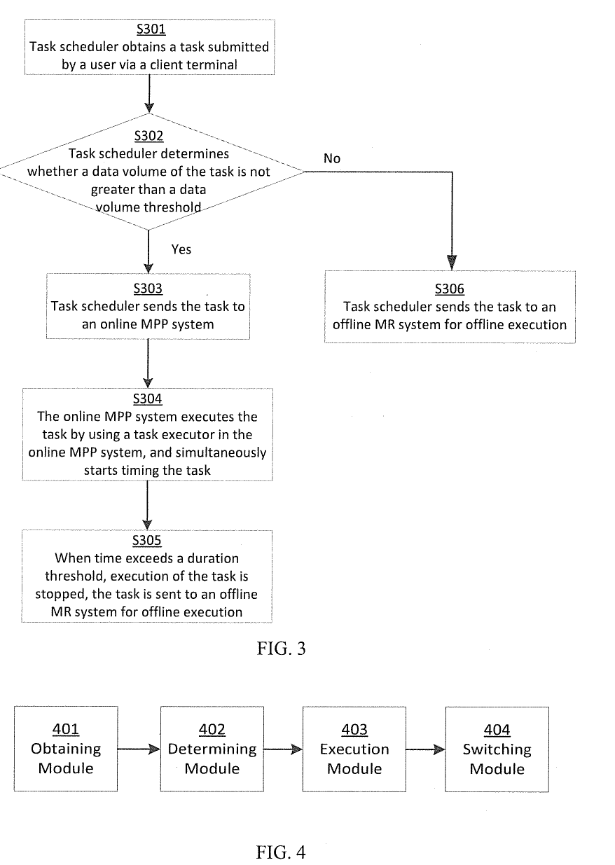

Reference is now made to FIG. 3, which is a flow chart illustrating an exemplary process of executing a task in a cluster, consistent with embodiments of the present disclosure. The exemplary process can be performed by a cluster architecture (e.g., by cluster 205 of FIG. 2). The process includes the following steps.

At step S301, a task scheduler (e.g., task scheduler 210 of FIG. 2) obtains a to-be-executed task submitted by a user via a client terminal. At step S302, the task scheduler determines whether a data volume of the to-be-executed task is not greater than a data volume threshold. If the data volume of the to-be-executed task is not greater than the data volume threshold, the method proceeds to step S303. At step S303, the task scheduler sends the to-be-executed task to an online MPP system. At step S304, the online MPP system (e.g., MPP system 220 of FIG. 2) executes the to-be-executed task by using a task executor included in the online MPP system, and starts to time the execution of the to-be-executed task. At step S305, when time is not greater than a duration threshold, the execution of the to-be-executed task continues; when time exceeds the duration threshold, the execution of the to-be-executed task is stopped, and the to-be-executed task is sent to an offline MR system for offline execution. If, however, the data volume of the to-be-executed task is greater than the data volume threshold, the method proceeds to step S306. At step S306, the task scheduler sends the to-be-executed task to the offline MR system (e.g., MR system 230 of FIG. 2) for offline execution directly. It is appreciated that, in some embodiments, step S306 is performed when the data volume of the to-be-executed task is equal to the data volume threshold.

The foregoing describes the method for executing a task in a cluster according to embodiments of the present application.

Reference is now made to FIG. 4, which is a schematic diagram illustrating an exemplary apparatus for executing a task in a cluster, consistent with embodiments of the present disclosure. The apparatus includes an obtaining module 401, a determining module 402, an execution module 403, and a switching module 404.

A module can be a packaged functional hardware unit designed for use with other components (e.g., portions of an integrated circuit) or a part of a program (stored on a computer readable medium) that performs a particular function of related functions. The module can have entry and exit points and can be written in a programming language, such as, for example, Java, Lua, C or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other non-transitory medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedding in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. Generally, the modules described herein refer to logical modules that can be combined with other modules or divided into sub-modules despite their physical organization or storage.”

Obtaining module 401 is configured to obtain a to-be-executed task.

Determining module 402 is configured to determine, in cluster-resource collections which are grouped in advance, a cluster-resource collection corresponding to the to-be-executed task according to attribute of the to-be-executed task.

Execution module 403 is configured to execute the to-be-executed task by using a cluster resource included in the determined cluster-resource collection.

The cluster-resource collections include at least a cluster-resource collection for providing a cluster resource for executing a task online, and a cluster-resource collection for providing a cluster resource for executing a task offline.

When an attribute of the to-be-executed task includes data volume, determining module 402 is further configured to determine whether the data volume of the to-be-executed task is not greater than a data volume threshold. If the data volume of the to-be-executed task is not greater than a data volume threshold, determine the cluster-resource collection for providing a cluster resource for executing a task online as the cluster-resource collection corresponding to the to-be-executed task. If the data volume of the to-be-executed task is greater than a data volume threshold, determine the cluster-resource collection for providing a cluster resource for executing a task offline as the cluster-resource collection corresponding to the to-be-executed task.

When an attribute of the to-be-executed task includes the number of task instance decomposed from the to-be-executed task, determining module 402 is configured to determine whether the number of task instance decomposed from the to-be-executed task is not greater than an instance number threshold. If the number of task instance decomposed from the to-be-executed task is not greater than an instance number threshold, determine the cluster-resource collection for providing a cluster resource for executing a task online as the cluster-resource collection corresponding to the to-be-executed task. If the number of task instance decomposed from the to-be-executed task is greater than an instance number threshold, determine the cluster-resource collection for providing a cluster resource for executing a task offline as the cluster-resource collection corresponding to the to-be-executed task.

When the determined cluster-resource collection is the cluster-resource collection for providing a cluster resource for executing a task online, execution module 403 is configured to execute the to-be-executed task online. In particular, execution module 403 can use a cluster resource included in the cluster-resource collection for providing a cluster resource for executing a task online.

When the determined cluster-resource collection is the cluster-resource collection for providing a cluster resource for executing a task offline, execution module 403 is configured to execute the to-be-executed task offline. In particular, execution module 403 can use a cluster resource included in the cluster-resource collection for providing a cluster resource for executing a task offline.

In some embodiments of the disclosure, the apparatus further includes a switching module 404 configured to time a process of executing the to-be-executed task by execution module 403 online. When time exceeds a duration threshold, the execution of the to-be-executed task online is stopped, and the cluster resource occupied by the to-be-executed task is released. Accordingly, the to-be-executed task offline is executed by using the cluster-resource collection for providing a cluster resource for executing the to-be-executed task offline.

The apparatus shown in FIG. 4 may be located on a machine in the cluster.

The embodiments of the present disclosure provide a method and an apparatus for executing a task in a cluster. The method includes obtaining a to-be-executed task, determining, in cluster-resource collections formed after grouping in advance, a cluster-resource collection corresponding to the to-be-executed task according to an attribute of the to-be-executed task, and executing the to-be-executed task by using a cluster resource included in the determined cluster-resource collection. By means of this method, different to-be-executed tasks may correspond to different cluster-resource collections. Any to-be-executed task may occupy only a cluster resource included in a cluster-resource collection corresponding to the to-be-executed task, instead of occupying all cluster resources in a cluster. Therefore, even if a to-be-executed task occupies all cluster resources included in a cluster-resource collection corresponding to the to-be-executed task for a long time, the cluster can still use a cluster resource included in another cluster-resource collection to execute another to-be-executed task corresponding to another cluster-resource collection in a timely manner.

It is appreciated that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is stored in a computer readable medium (including but not limited to a magnetic disk memory, a CD-ROM, an optical memory, and the like) that include computer-executable program code.

The present disclosure is described with reference to flowcharts and/or block diagrams according to the method, device (system) and computer program product according to the embodiments of the present disclosure. It should be understood that a computer program instruction may be used to implement each process and/or block in the flowcharts and/or block diagrams and combinations of processes and/or blocks in the flowcharts and/or block diagrams. These computer program instructions may be provided for a computer, an embedded processor, or a processor of any other programmable data processing device to generate a machine, so that the instructions executed by a computer or a processor of any other programmable data processing device generate an apparatus for implementing a specified function in one or more processes in the flowcharts and/or in one or more blocks in the block diagrams.

These computer program instructions may also be stored in a computer readable medium that can instruct the computer or any other programmable data processing device to work in a specific way, so that the instructions stored in the computer readable medium generate a product that includes an apparatus to execute the instructions. The apparatus to execute the instructions implements a specified function in one or more processes in the flowcharts and/or in one or more blocks in the block diagrams.

These computer program instructions may also be loaded onto a computer or a programmable data processing device, so that a series of operations and steps are performed on the computer or the programmable device, to generate computer-implemented processing. Therefore, the instructions executed on the computer or the programmable device provide steps for implementing a function in one or more processes in the flowcharts and/or in one or more blocks in the block diagrams.

In a typical configuration, a computing device includes one or more processors (CPU), an input/output interface, a network interface, and a memory.

The memory may include a volatile memory, a random-access memory (RAM) and/or a non-volatile memory or the like in a computer readable medium, for example, a read-only memory (ROM) or a flash memory (flash RAM). The memory is an example of the computer readable medium.

The computer readable medium includes non-volatile and volatile media as well as movable and non-movable media, and can implement information storage by using any method or technology. Information may be a computer readable instruction, a data structure, and a module of a program or other data. A storage medium of a computer includes, for example, but is not limited to, a phase change memory (PRAM), a static RAM (SRAM), a dynamic RAM (DRAM), other types of RAMs, a ROM, an electrically erasable programmable ROM (EEPROM), a flash memory or other memory technologies, a compact disk ROM (CD-ROM), a digital versatile disc (DVD) or other optical storages, a cassette tape, a magnetic tape/magnetic disk storage or other magnetic storage devices, or any other non-transmission medium, and can be used to store information that can be accessed by the computing device. According to the definition of this text, the computer readable medium does not include transitory computer readable media (transitory media), such as a modulated data signal and a carrier.

The above descriptions are merely embodiments of the present disclosure, and are not intended to limit the present disclosure. For those skilled in the art, the present disclosure may have various modifications and variations. Any modification, equivalent replacement, improvement or the like made without departing from the spirit and principle of the present disclosure should all fall within the scope of claims of the present disclosure.

1. A method for executing a task in a cluster, comprising:
obtaining a task;
determining, according to an attribute of the task, a cluster-resource collection corresponding to the task in a plurality of pre-grouped cluster-resource collections; and
executing the task by a cluster resource of the determined cluster-resource collection.

2. The method of claim 1, wherein the cluster-resource collection comprises a cluster resource for executing a task online and a cluster resource for executing a task offline.

3. The method of claim 2, wherein the determining of a cluster-resource collection corresponding to the task further comprises:
comparing the attribute of the task to an attribute threshold; and
determining, based on the comparison, a cluster-resource collection for providing the cluster resource for executing the task online or the cluster resource for executing the task offline.

4. The method of claim 3, wherein the attribute of the task comprises a data volume.

5. The method of claim 3, wherein the attribute of the task comprises the number of task instance decomposed from the task.

6. The method of claim 3, further comprising,
determining the cluster-resource collection for providing a cluster resource for executing a task online as the cluster-resource collection corresponding to the task, in response to the data volume of the task less than or equal to the data volume threshold.

7. The method of claim 3, further comprising,
determining the cluster-resource collection for providing a cluster resource for executing a task offline as the cluster-resource collection corresponding to the task, in response to the data volume of the task is greater than or equal to the data volume threshold.

8. The method of claim 3, wherein
executing of the task comprises executing the task online, in response to the determined collection of cluster resource being the collection of cluster resource for providing a cluster resource for executing a task online; or
executing of the task comprises executing the task offline, in response to the determined cluster-resource collection being the cluster-resource collection for providing a cluster resource for executing a task offline.

9. The method of claim 8, wherein the executing of the task comprises executing the task online, the method further comprises:
timing the online execution of the task; and
in response to the time exceeds a duration threshold,
stopping executing the task online,
releasing the cluster resource occupied by the task; and
executing the task offline by using the cluster-resource collection for providing a cluster resource for executing a task offline.

10. An apparatus for executing a task in a cluster, comprising:
an obtaining module configured to obtain a task;
a determining module configured to determine a cluster-resource collection corresponding to the task in a plurality of pre-grouped cluster-resource collection, according to attribute of the task; and
an execution module configured to execute the task by using a cluster resource in the determined cluster-resource collection.

11. The apparatus of claim 10, wherein the cluster-resource collection comprise at least: a cluster-resource collection for providing a cluster resource for executing a task online, and a cluster-resource collection for providing a cluster resource for executing a task offline.

12-15. (canceled)

16. A non-transitory computer readable medium storing a set of instructions that is executable by one or more processors of a task scheduler to cause the task scheduler to perform a method comprising:
obtaining a task;
determining, according to attribute of the task, a cluster-resource collection corresponding to the task in a plurality of pre-grouped cluster-resource collections; and
instructing a cluster resource in the determined cluster-resource collection to execute the task.

17. The non-transitory computer readable medium of claim 16, wherein the cluster-resource collection comprise a cluster resource for executing a task online and a cluster resource for executing a task offline.

18. The non-transitory computer readable medium of claim 17, wherein the determining of a cluster-resource collection corresponding to the task further comprises:
comparing the attribute of the task to an attribute threshold; and
determining, based on the comparison, a cluster-resource collection for providing the cluster resource for executing the task online or the cluster resource for executing the task offline.

19. The non-transitory computer readable medium of claim 18, wherein the attribute of the task comprises a data volume.

20. The non-transitory computer readable medium of claim 18, wherein the attribute of the task comprises the number of task instance decomposed from the task.

21. The non-transitory computer readable medium of claim 18, the set of instructions to further cause the task scheduler to perform a method comprising,
determining the cluster-resource collection for providing a cluster resource for executing a task online as the cluster-resource collection corresponding to the task, in response to the data volume of the task less than or equal to the data volume threshold.

22. The non-transitory computer readable medium of claims 18, the set of instructions to further cause the task scheduler to perform a method comprising,
determining the cluster-resource collection for providing a cluster resource for executing a task offline as the cluster-resource collection corresponding to the task, in response to the data volume of the task is greater than or equal to the data volume threshold.

23. The non-transitory computer readable medium of claim 18, wherein
executing of the task comprises executing the task online, in response to the determined collection of cluster resource being the collection of cluster resource for providing a cluster resource for executing a task online; or
executing of the task comprises executing the task offline, in response to the determined cluster-resource collection being the cluster-resource collection for providing a cluster resource for executing a task offline.

24. The non-transitory computer readable medium of claim 23, wherein executing of the task comprises executing the task online, the method further comprises:
timing the online execution of the task; and
in response to the time exceeds a duration threshold,
stopping executing the task online,
releasing the cluster resource occupied by the task; and
executing the task offline by using the cluster-resource collection for providing a cluster resource for executing a task offline.
